(19) United States
(12) Patent Application Publication
(10) Pub. No.: US 2017/0070620 A1
(43) Pub. Date: Mar. 9, 2017

(54) NONVOLATILE SEMICONDUCTOR MEMORY DEVICE, MEMORY DEVICE AND STORAGE MEDIUM STORING CONTROL PROGRAM

(71) Applicant: Kabushiki Kaisha Toshiba, Minato-ku (JP)

(72) Inventors: Shinya OHASHI, Kamakura (JP); Junichi ASADA, Sagamihara (JP); ltaru MORI, Kamakura (JP)

(73) Assignee: Kabushiki Kaisha Toshiba, Minato-ku (JP)

(21) Appl. No.: 15/016,962

(22) Filed: Feb. 5, 2016

Related U.S. Application Data
(60) Provisional application No. 62/214,533, filed on Sep. 4, 2015.

(51) Int. Cl. H04N 1/00; G06Q 30/00; G06K 15/02

(52) U.S. Cl. CPC H04N 1/0087; G06K 15/021; G06Q 30/0185

(57) ABSTRACT

According to one embodiment, a nonvolatile semiconductor memory device includes a case, a memory in the case, a controller in the case. The controller controls the memory. First information including a determination code is printed on a surface of the case with invisible ink. Second information related to the nonvolatile semiconductor memory device is printed with visible ink which is visually recognizable in a visible light range.

### CROSS-REFERENCE TO RELATED APPLICATIONS

This application is based upon and claims the benefit of priority from U.S. Provisional Application No. 62/214,533, filed on Sep. 4, 2015; the entire contents of which are incorporated herein by reference.

### FIELD

Embodiments described herein relate generally to a nonvolatile semiconductor memory device, a memory device, and a storage medium storing a control program.

### BACKGROUND

Sometimes, counterfeit memory cards similar to a genuine memory card manufactured by a maker are on the market. In some cases, it is difficult to determine whether the memory card spreading in the market is a genuine product or a counterfeit product.

### BRIEF DESCRIPTION OF THE DRAWINGS

FIG. 1A and FIG. 1B are top views illustrating a configuration of a memory device according to a first embodiment;

FIG. 2 is a diagram illustrating an example of traceability information;

FIG. 3 is a diagram illustrating an example of traceability information according to the first embodiment;

FIG. 4 is a diagram illustrating an example of a calculating method for a determination code;

FIG. 5 is a diagram illustrating an example of the calculation method according to the first embodiment;

FIG. 6 is a diagram illustrating another example of the calculating method for a determination code;

FIG. 7 is a flowchart illustrating an example of a procedure of authenticity determination for a memory device;

FIG. 8A and FIG. 8B are diagrams illustrating a modified example of the memory device according to the first embodiment as a first modified example in a case where another printing example of product information is illustrated;

FIG. 9A to FIG. 9D are diagrams illustrating a modified example of the memory device according to the first embodiment as a second modified example in a case where still another printing example of product information is illustrated;

FIG. 10A and FIG. 10B are diagrams illustrating a modified example of the memory device according to the first embodiment as a third modified example in a case where further still another printing example of product information is illustrated;

FIG. 11A is a schematic perspective diagram illustrating an example of a configuration of a USB memory which is a memory device according to a second embodiment;

FIG. 11B is a schematic exploded perspective diagram illustrating the example of the configuration of the USB memory which is the memory device according to the second embodiment;

FIG. 12 is a schematic perspective diagram illustrating another example of the configuration of the USB memory according to the second embodiment;

FIG. 13 is a schematic block diagram illustrating an example of a configuration of a memory device according to a third embodiment;

FIG. 14 is a flowchart illustrating an example of a procedure of the traceability information identifying method according to the third embodiment;

FIG. 15 is a schematic diagram illustrating a summary of the traceability information identifying method according to the third embodiment;

FIG. 16 is a flowchart illustrating an example of a procedure of authenticity determination using traceability information according to the third embodiment; and

FIG. 17A and FIG. 17B are schematic diagrams illustrating a summary of an authenticity determination method for the memory device according to the third embodiment.

### DETAILED DESCRIPTION

According to one embodiment, a nonvolatile semiconductor memory device includes a case, a memory in the case, a controller in the case. The controller controls the memory. First information including a determination code is printed on a surface of the case with invisible ink. Second information related to the nonvolatile semiconductor memory device is printed with visible ink which is visually recognizable in a visible light range.

A nonvolatile semiconductor memory device, a memory device, and a storage medium storing a control program according to some embodiments will be described below in detail with reference to the attached drawings. Note that the present invention is not limited to the embodiments. In addition, top views, bottom views, and perspective diagrams of memory devices used in the embodiments described hereinafter are schematic views and diagrams, and thus, in some cases, relations and ratios among lengths, widths, and depths or the like may not be different from actual ones.

### First Embodiment

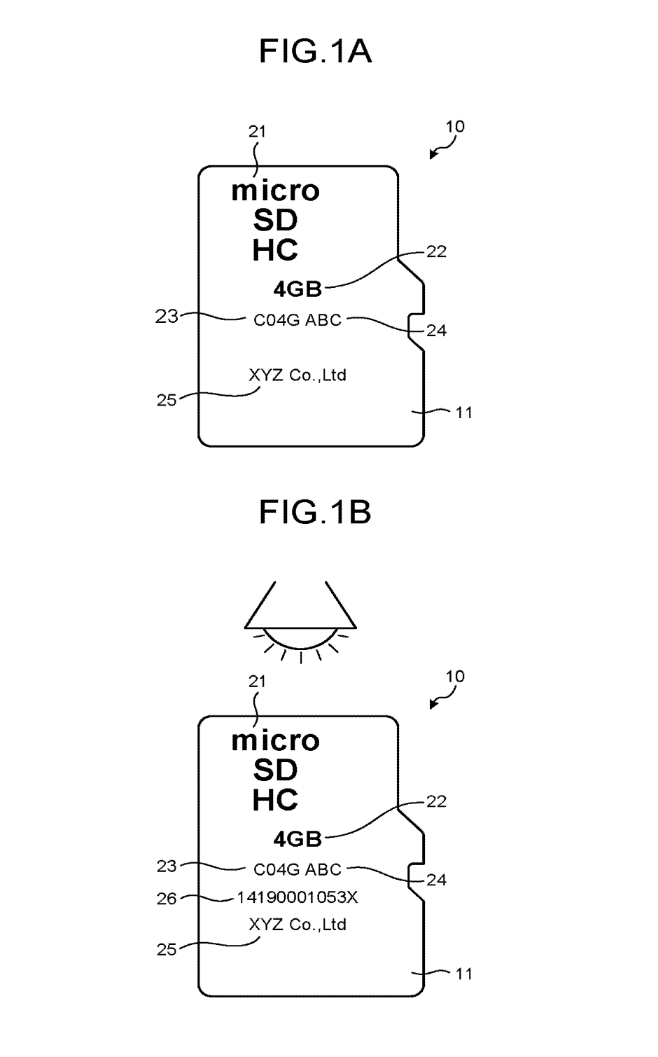

FIG. 1A and FIG. 1B are top views illustrating a configuration of a memory device 10 according to a first embodiment. FIG. 1A is a top view of the memory device 10 in a normal state, and FIG. 1B is a top view of the memory device 10 in a state where invisible ink is visualized. Herein, a microSD card is exemplified as the memory device 10. The memory device 10 is a nonvolatile semiconductor memory device having a configuration where a stack structure where a plurality of memory chips (not illustrated) configured to include nonvolatile memory and a controller chip (not illustrated) controlling the memory chips are stacked is sealed in a certain shape by a molding resin 11. The molding resin 11 constitutes a case. The plurality of the memory chips and the controller chip are connected to each other by wires.

The nonvolatile memory is, for example, a NAND type flash memory. However, other nonvolatile memories such as a NOR type flash memory, an MRAM (a magnetoresistive random access memory: a magnetoresistive memory), a PRAM (a phase change random access memory: a phase change memory), an ReRAM (a resistive random access memory: a variable resistance memory), and an FeRAM (a ferroelectric random access memory) may be used.

Product information on the memory device 10 is printed on the top surface of the molding resin 11. As the product information, for example, a name 21 named to the memory device 10, a storage capacity 22, a model number 23, a country-of-origin indication 24, traceability information 26, a manufacturer's name 25, and the like may be exemplified. In the product information, the name 21, the storage capacity 22, the model number 23, the country-of-origin indication 24, and the manufacturer's name 25 are printed in a method where a printing result can be visually recognized in a visible light range such as laser engraving or pad printing. During the printing in the laser engraving, there is a possibility that the memory chips or the controller chip is damaged through the molding resin 11. For this reason, printing is not performed on a region corresponding to a wire portion of the stack structure. In general, since the wire exists in the vicinity of a peripheral portion of the molding resin 11, printing is not performed on the peripheral portion.

The traceability information of the memory device 10 is information by which a manufacturing time, a manufacturing location, and the like of the product can be traced. For example, the traceability information is information used to investigate product history of a case where there is a defect in the product. For example, the traceability information of a memory card is directly displayed on the actual product in a method such as laser engraving or pad printing. In this case, a region for displaying the traceability information needs to be secured on a surface of the product.

In the first embodiment, in the product information, the traceability information 26 is printed on the surface of the molding resin 11 as a case, by the pad printing using invisible ink. The invisible ink is ink which is not visually recognized in the state where only the light in the visible light range is irradiated after the printing. Namely, the invisible ink is ink which is substantially transparent to visible light. On the other hand, the invisible ink is ink which is visually recognized when light having a certain wavelength other than the visible light range is irradiated. Namely, the invisible ink is ink which emits visible light when light having a certain wavelength other than the visible light range is irradiated. As the ink, for example, ultraviolet irradiation type fluorescence ink, infrared irradiation type fluorescence ink, or the like may be used. The ultraviolet irradiation type fluorescence ink emits fluorescent light to be visualized when ultraviolet light is irradiated on a site printed with the ink. In addition, the infrared irradiation type fluorescence ink emits fluorescent light to be visualized when infrared light is irradiated on a site printed with the ink. In contrast, ink which is not the invisible ink but is printed on the surface of the molding resin 11 by laser engraving or pad printing where the ink can be visually recognized in a visible light range is called visible ink.

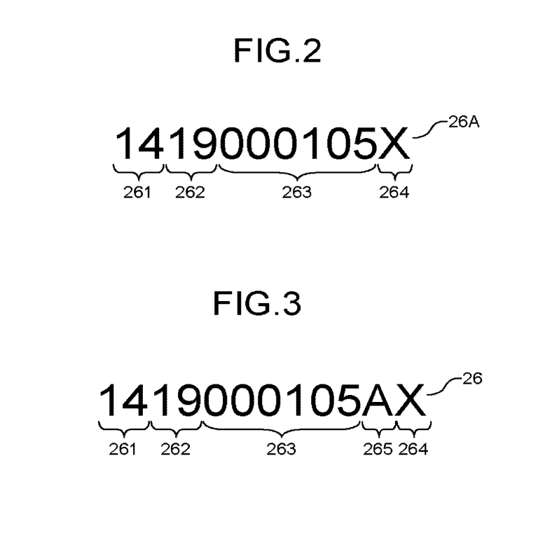

FIG. 2 is a diagram illustrating an example of the traceability information. As illustrated in this figure, traceability information 26A is configured to include a character string of a combination of a two-digit year number 261, a two-digit week number 262, a six-digit key number 263, and a one-digit controller code 264. The year number 261 is the last two digits of the year when the memory device 10 was manufactured. The week number 262 is a week number in the year when the memory device 10 was manufactured. The key number 263 includes information indicating a manufacturing base and a lot number. The controller code 264 indicates a type of the controller chip.

The traceability information 26A is important for the manufacturer to trace a manufacturing time, a manufacturing location, and the like of the product. In a case where a counterfeit product looking like a genuine product is manufactured, it is difficult to determine whether the product is counterfeit or not. Therefore, in the first embodiment, a determination code for determining whether a product is genuine or not is included in the traceability information 26.

FIG. 3 is a diagram illustrating an example of the traceability information according to the first embodiment. As illustrated in FIG. 3, the traceability information 26 according to the first embodiment includes a one-digit determination code 265 “A” between the key number 263 and the controller code 264. Note that although, in this example, the determination code 265 is of one digit, the determination code may be of two or more digits. In addition, the determination code 265 may be arranged not between the key number 263 and the controller code 264 but at another position.

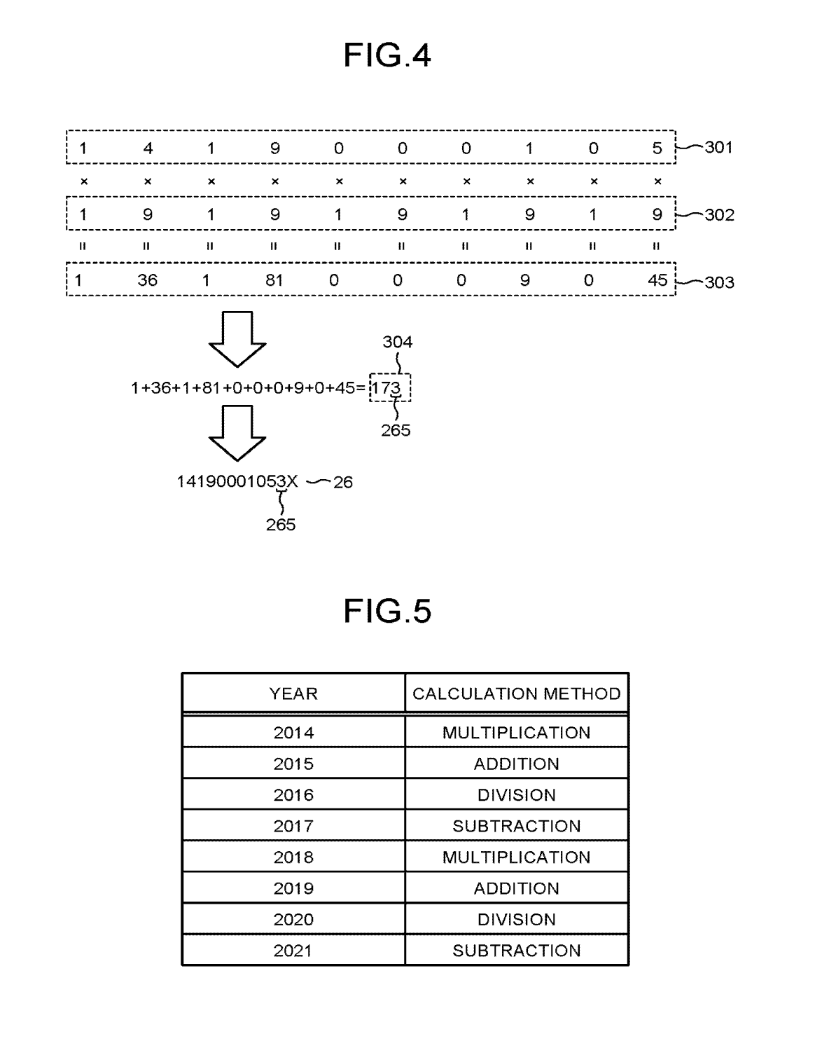

FIG. 4 is a diagram illustrating an example of a calculating method for the determination code. First, in the traceability information 26A of FIG. 2, an operand number 301, which is configured to include ten-digit number “1419000105” excluding the controller code 264, is arranged. In addition, the week number 262 “19” in the traceability information 26 is acquired, and the week number 262 is repetitively arranged, so that an operating number 302 configured to include a ten-digit number is generated. Herein, as the operating number 302, “1919191919” is generated.

After that, numeric values of every digit of the ten-digit operand number 301 and numeric values of every digit of the ten-digit operating number 302 are calculated by a certain method. Herein, multiplication is performed. In the example of FIG. 4, calculation results 303 for the respective digits are “1”, “36”, “1”, “81”, “0”, “0”, “0”, “9”, “0”, and “45”.

Next, a total sum 304 of the calculation results 303 for the digits is obtained. In the example of FIG. 4, by adding the calculation results 303 for the digits, the total sum 304 becomes “173”. Furthermore, the last one digit of the total sum 304 is defined as the determination code 265. In this example, the determination code 265 is “3”. As a result, the traceability information 26 according to the first embodiment becomes “14190001053X”. The traceability information 26 including the determination code 265 is printed on the top surface of the molding resin 11 of the memory device 10 with the invisible ink.

In addition, in the above description, the operating number 302 is generated using the week number 262. However, the operating number may be generated using the year number 261, or using the year number 261 and the week number 262. However, using a number changed in a short term as the operating number 302 instead of using the same number in a long term makes it possible to easily detect a counterfeit product. For this reason, it is preferable that the week number 262 which is changed every week be included.

In addition, in the above description, the multiplication of the digit numbers of the operand number 301 and the operating number 302 is illustrated. However, a different calculation method may be used. FIG. 5 is a diagram illustrating an example of the calculation methods according to the first embodiment. In FIG. 5, calculation-method information defining a calculation method for every year is defined in advance, and the determination code is calculated according to the calculation method.

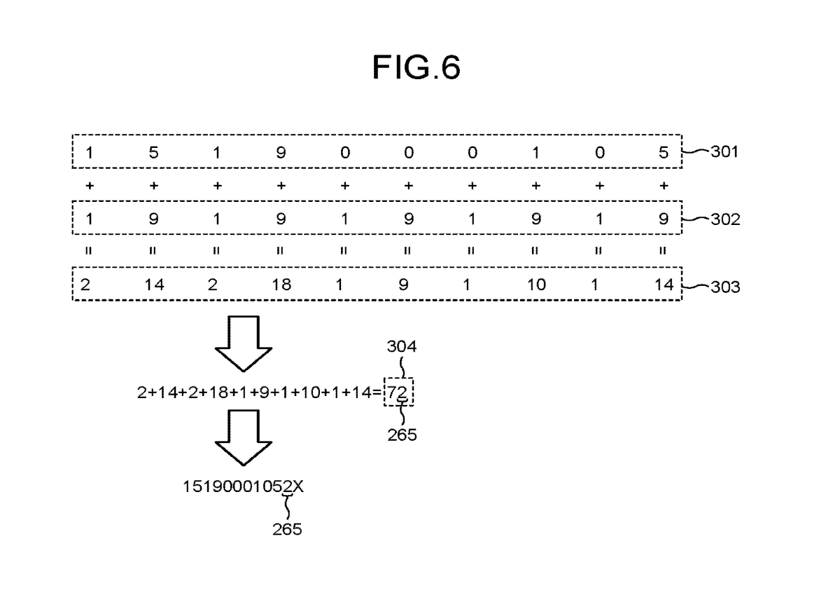

For example, with respect to the memory device 10 manufactured in 2015, addition is defined as the calculation method. FIG. 6 is a diagram illustrating another example of the calculating method for the determination code. First, the traceability information 26A of the memory device 10 is defined as “1519000105X”. In the traceability information 26A, an operand number 301 configured to include a ten-digit number “1519000105” excluding the controller code 264 is arranged. In addition, the week number 262 “19” in the traceability information 26 is acquired, and the week number 262 is repetitively arranged, so that an operating number 302 configured to include a ten-digit number “1919191919” is generated.

Since the year number 261 in the traceability information 26A is “15”, the calculation method corresponding to the year “15” (2015) acquired from the calculation-method information of FIG. 5 is “addition”. Therefore, numeric values of every digit of the ten-digit operand number 301 and numeric values of every digit of the ten-digit operating number 302 are added to each other. In the example of FIG. 6, calculation results 303 for the respective digits according to the first method are “2”, “14”, “2”, “18”, “1”, “9”, “1”, “10”, “1”, and “14”.

Next, by adding the calculation results 303 for the digits, a total sum 304 becomes “72”. Since the determination code 265 is the last one digit of the total sum 304, the determination code 265 is “2”. As a result, the traceability information 26 including the determination code 265 is “15190001052X”.

Furthermore, FIG. 5 is merely an example, and the calculation method may be defined for every week number 262 instead of the year number 261. For example, the operating number 302 is generated using the year number 261, and the calculation may be performed according to a calculation method defined for every week number 262.

In addition, in a case where a character other than a number is included in the traceability information 26, calculation excluding the character may be performed. Alternatively, the character other than a number is converted into a number, and calculation may be performed. For example, in a case where alphabets are used, A, B, C, . . . , and Z may be in correspondence with “1”, “2”, “3”, . . . , and “26”, respectively.

After the traceability information 26 including the determination code 265 is printed with invisible ink, the traceability information 26 is not visible as illustrated in FIG. 1A. However, when the ultraviolet light or the infrared light is irradiated, as illustrated in FIG. 1B, the invisible ink emits light, and thus, the traceability information 26 is displayed. Therefore, by using the traceability information 26, manufacturers or the like of the memory device 10 can investigate product history of a case where there is a defect in the product or can perform authenticity determination on a case where the product is suspected to be a counterfeit product.

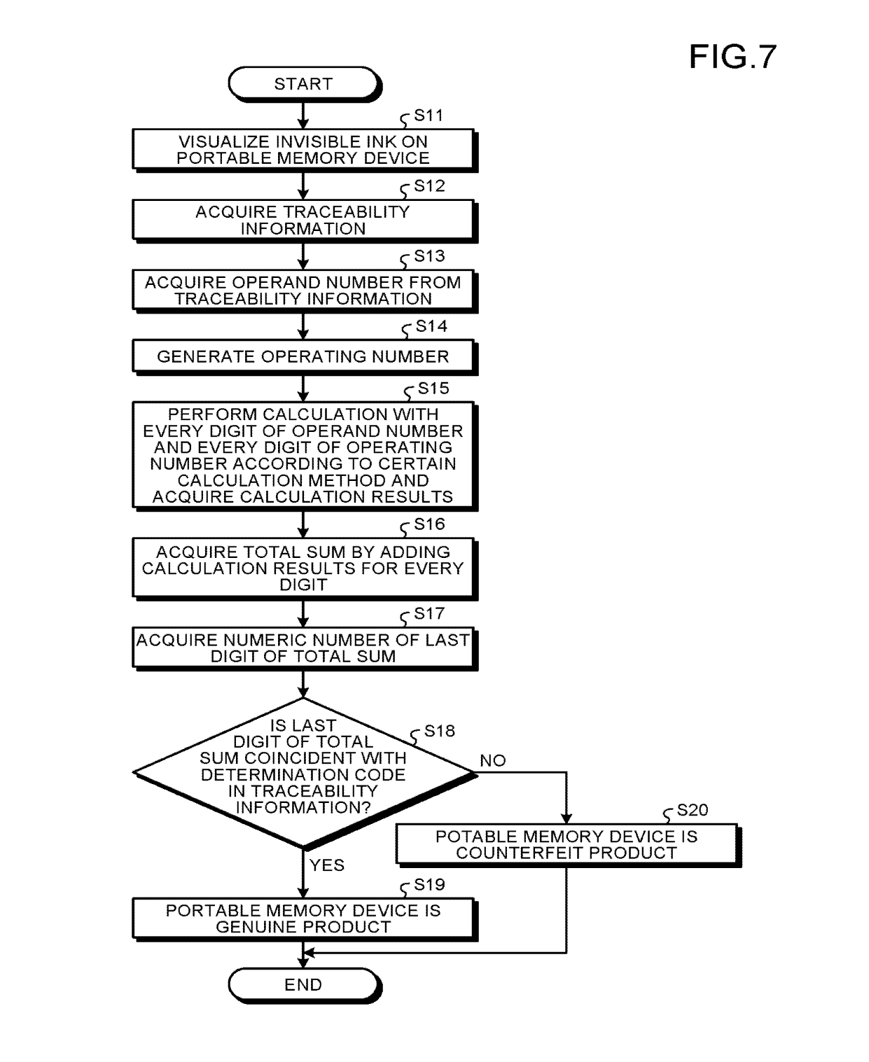

FIG. 7 is a flowchart illustrating an example of a procedure of authenticity determination for the memory device 10. First, the invisible ink of the memory device 10 is visualized (step S11). For example, ultraviolet light or infrared light is irradiated, so that the invisible ink emits light. Next, the traceability information 26 including the emitted determination code 265 is acquired (step S12). Next, the operand number 301 is acquired from the traceability information 26 (step S13). In the above example, it is obtained by excluding determination code 265 and the controller code 264 from the traceability information 26 including the determination code 265.

Next, the operating number 302 is generated (step S14). For example, the week number 262 is acquired from the traceability information 26 or the operand number 301, and numeric values of the same digits as those of the operand number 301 is generated by the week number 262. Next, the calculation results 303 are acquired by performing calculation with the numeric values of every digit of the operand number 301 and the numeric values of every digit of the operating number 302 according to a certain calculation method (step S15). As the calculation method, for example, multiplication can be used. Next, the total sum 304 is acquired by adding the calculation results 303 for the every digit (step S16). Next, the numeric value of the last one digit of the total sum 304 is acquired (step S17).

Next, it is determined whether or not the last one digit of the total sum is coincident with the determination code in the traceability information 26 acquired in step S12 (step S18). In a case where both are coincident with each other (in a case of Yes in step S18), it is determined that the memory device 10 as a determination object is a genuine product (step S19), and the process ends. Alternatively, in a case where both are not coincident (in a case of No in step S18) it is determined that the memory device 10 as a determination object is a counterfeit product (step S20), and the process ends.

The authenticity determination is performed by the user of the memory device 10. In addition, the user of the memory device 10 may prepare a dedicated apparatus capable of recognizing the traceability information 26 by irradiating ultraviolet light or infrared light for allowing the invisible ink to emit light and by scanning characters emitted by the irradiation, and the dedicated apparatus may execute, for example, the procedure illustrated in FIG. 7, so that it may be determined whether or not the memory device 10 as a determination object is a genuine product.

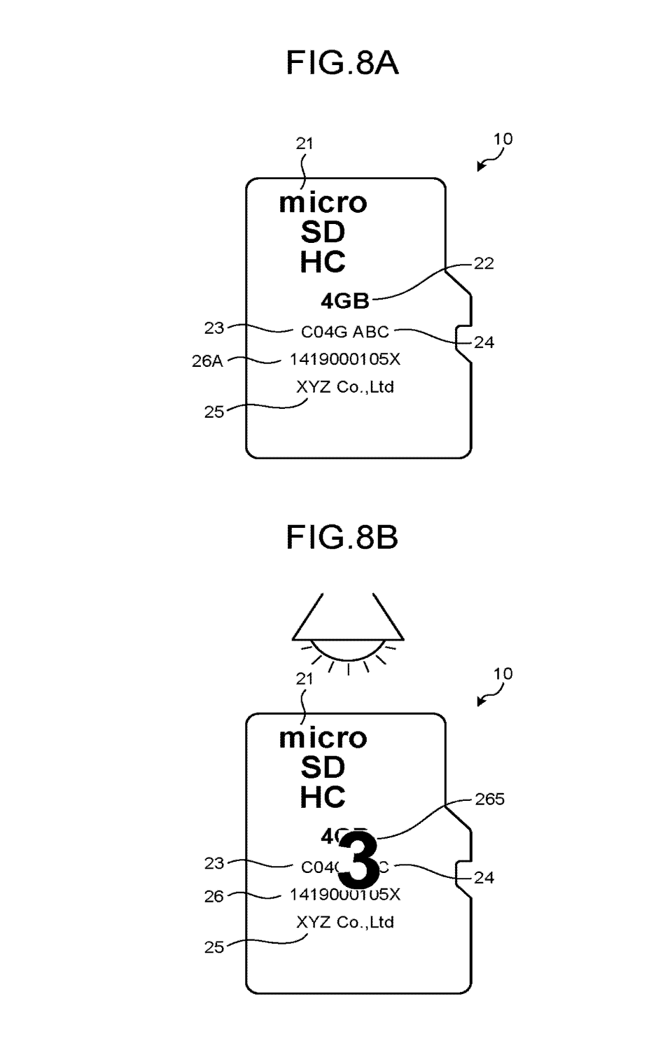

In addition, in the above description, the case where the traceability information 26 including the determination code 265 is printed with the invisible ink is exemplified, but the embodiment is not limited thereto. FIG. 8A and FIG. 8B are diagrams illustrating a modified example of the memory device 10 according to the first embodiment as a first modified example in a case where another printing example of product information is illustrated. FIG. 8A is a top view of the memory device 10 in a normal state, and FIG. 8B is a top view of the memory device 10 in a state where invisible ink is visualized. As illustrated in FIG. 8A, the traceability information 26A including no determination code may be printed with visible ink on the top surface of the memory device 10, and the determination code 265 may be printed with invisible ink on the top surface of the memory device 10. The visible ink is printed on the top surface of the memory device 10 by laser engraving or pad printing. In addition, as illustrated in FIG. 8B, when ultraviolet light or infrared light is irradiated, the determination code 265 may be visualized. At this time, the determination code 265 may be printed to be superimposed on characters or figures printed by laser engraving or pad printing.

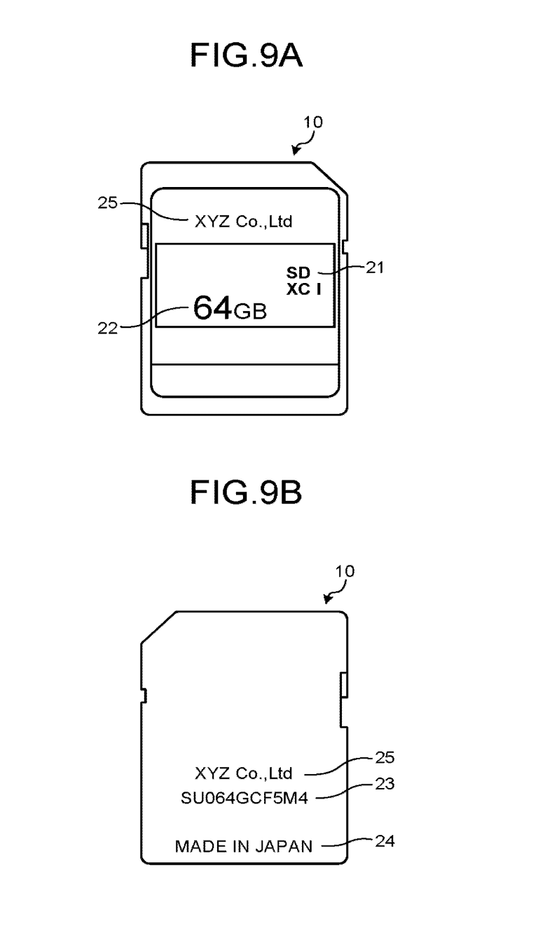

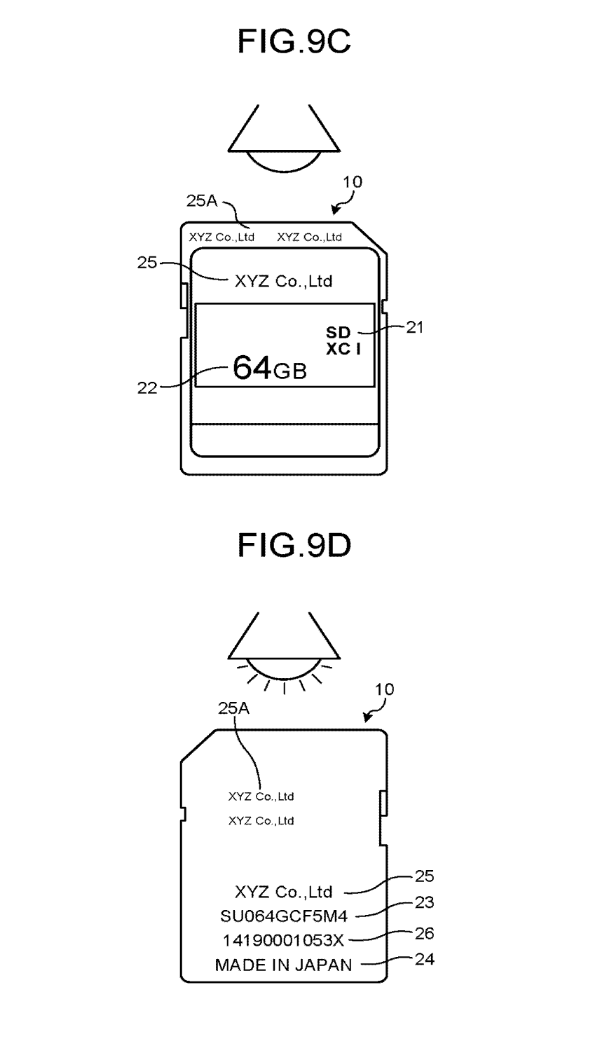

FIG. 9A to FIG. 9D are diagrams illustrating a modified example of the memory device 10 according to the first embodiment as a second modified example in a case where still another printing example of product information is illustrated. FIG. 9A is a top view of the memory device 10 in a normal state, and FIG. 9B is a bottom view of the memory device 10 in the normal state. FIG. 9C is a top view of the memory device 10 in the state where invisible ink is visualized, and FIG. 9D is a bottom view of the memory device 10 in the state where invisible ink is visualized. In FIG. 9A to FIG. 9D, an SD card is exemplified as the memory device 10.

As illustrated in FIG. 9A and FIG. 9B, the name 21 named to the memory device 10, the storage capacity 22, the manufacturer's name 25, and the like are printed on the top surface of the memory device 10 by laser engraving or pad printing, and the model number 23, the country-of-origin indication 24, the manufacturer's name 25, and the like are printed on the bottom surface by laser engraving or pad printing.

When ultraviolet light or infrared light is irradiated on the memory device 10, as illustrated in FIG. 9C and FIG. 9D, in addition to the traceability information 26 including the determination code printed with the invisible ink on the bottom surface, the manufacturer's name 25A printed with the invisible ink on an upper peripheral portion of the top surface and in the vicinity of an upper portion of the bottom surface is displayed. In addition, in the product information, the model number 23, the country-of-origin indication 24, and the like may be printed with the invisible ink without being printed by laser engraving or pad printing. In this manner, the product information is printed with the invisible ink at a certain position, so that the authenticity determination for the memory device 10 can be easily performed. In addition, the position where the product information is printed with the invisible ink may be changed according to the year of manufacture or the week number. Therefore, although the product information is printed with invisible ink in a counterfeit product, the authenticity determination can be performed based on the printing position. In addition, the content of the product information printed with the invisible ink may be replaced with the year number 261 or the week number 262. Therefore, although the product information is printed with invisible ink in a counterfeit product, the authenticity determination can be performed based on the content of the printed product information.

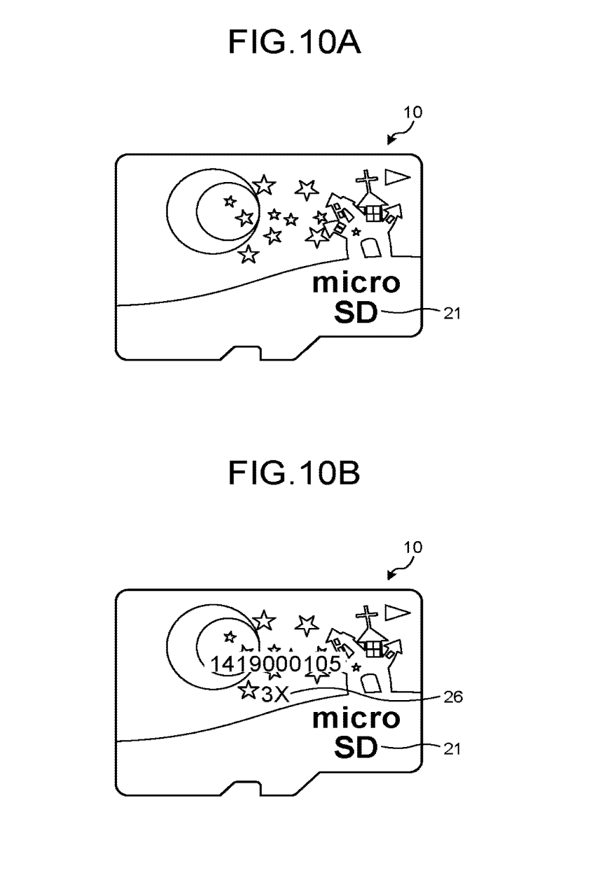

FIG. 10A and FIG. 10B are diagrams illustrating a modified example of the memory device 10 according to the first embodiment as a third modified example in a case where further still another printing example of product information is illustrated. FIG. 10A is a top view of the memory device 10 in a normal state, and FIG. 10B is a top view of the memory device 10 in a state where invisible ink is visualized. As illustrated in FIG. 10A, the name 21 of the memory device 10 and figures are drawn with visible ink on the top surface of the memory device 10. In addition, as illustrated in FIG. 10B, the traceability information 26 including the determination code is printed with invisible ink. In this manner, the information which is unnecessary for the user is printed with the invisible ink, so that the figures drawn on the top surface of the memory device 10 are not disturbed.

In addition, in the above description, the microSD card and the SD card are exemplified as the memory device 10, but other memory cards may be used. For example, the above embodiment can be applied to a miniSD card, a Compact Flash card, an xD picture card, a memory stick, a multimedia card, and the like.

In the first embodiment, in the product information on the memory device 10, the traceability information 26 including the determination code 265 for performing the authenticity determination for the memory device 10 is printed with the invisible ink. Therefore, it is possible to obtain an effect in that calculation using the traceability information 26 is performed on the product which is suspected to be a counterfeit product, and thus, the authenticity determination can be performed according to whether or not the result of calculation is coincident with the determination code 265.

In addition, it is possible to obtain an effect in that a time taken to perform the authenticity determination can be reduced by performing the authenticity determination with a simple method of determining whether or not the invisible ink is used and, subsequently, by performing detailed determination only in a case where the invisible ink is used.

In addition, besides the traceability information 26, information which does not cause problems without always being displayed in the product information is printed with the invisible ink, so that the printing area for such information can be reduced. As a result, the printing area for displaying other part of the product information with visible ink can be enlarged. Therefore, it is possible to obtain an effect in that necessary information can be printed with a larger size than that of the related art with the visible ink, for example, with respect to the memory device 10 having a small surface area such as a microSD card.

### Second Embodiment

In the first embodiment, a memory card is exemplified as the memory device. In a second embodiment, a USB (universal serial bus) memory is exemplified as the memory device.

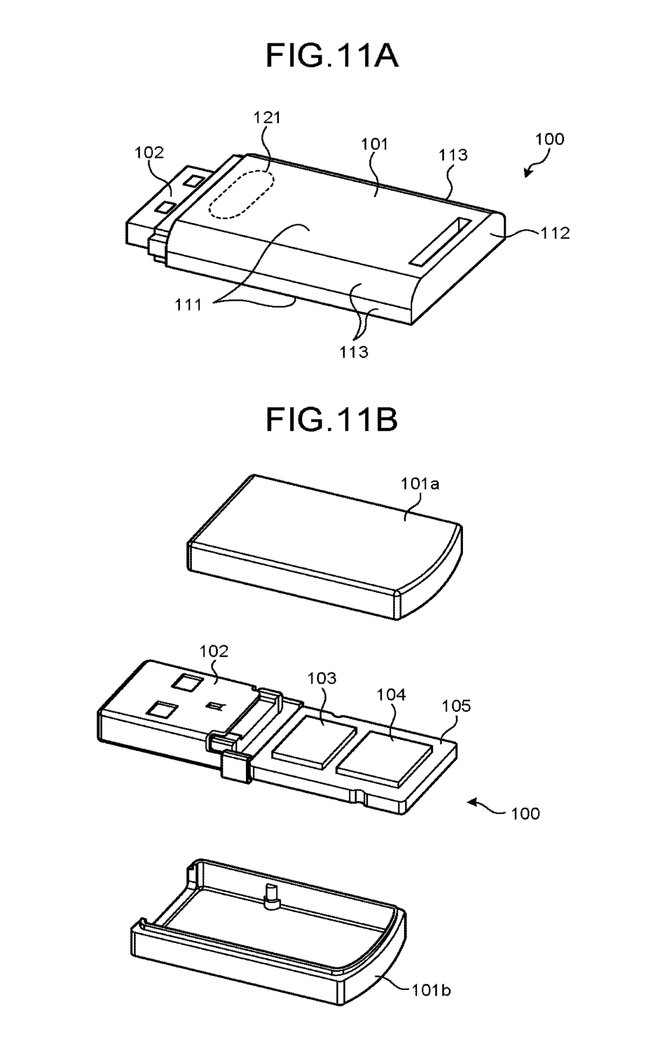

FIG. 11A is schematic perspective diagram illustrating an example of a configuration of a USB memory 100 which is a memory device according to the second embodiment. FIG. 11B is a schematic exploded perspective diagram illustrating the example of the configuration of the USB memory 100 which is the memory device according to the second embodiment. The USB memory 100 is configured to include a board 105 on which a USB connector 102, a controller chip 103, a memory chip or a memory package 104, and the like are mounted and which is enclosed in a case 101 having an upper case 101a and a lower case 101b. The memory chip or memory package 104 is a nonvolatile semiconductor memory such as a NAND type flash memory. The controller chip 103 controls the memory chip or the memory package 104 to read or write information. The USB connector 102 is an interface for connection to an external device equipped with a USB socket.

Production information is printed in the USB memory 100. The production information is printed on a surface of the case 101. In addition, similarly to the first embodiment, the traceability information 26 is printed in the USB memory 100 with invisible ink. Besides the traceability information 26, the manufacturer's name 25 or the like may be printed with the invisible ink. In addition, the method of printing the traceability information 26 in the USB memory 100 with the invisible ink is the same as that of the first embodiment, and thus, the description thereof will not be repeated.

The USB memory 100 is frequently carried by its user. Therefore, if the printing is performed on the site which is frequently touched by the user, there is a possibility that the invisible ink can be peeled off as a result of long-term use. Accordingly, it is preferable that the printing be performed on the site which is not frequently touched by the user. A pair of surfaces of the case 101 which are parallel to a board plane of a board 105 are defined as main surfaces 111; the surface of the case 101 at the side opposite to the USB connector 102 is defined as an end surface 112; and the surfaces of the case 101 excluding the main surfaces 111 and the end surface 112 are defined as side surfaces 113.

For example, in general, since positions 121 of the main surfaces 111 of the case 101 close to the USB connector 102, the end surface 112, and the portions of the side surfaces 113 close to the end surface 112 are not frequently touched, it is preferable that the traceability information 26 be printed on these positions.

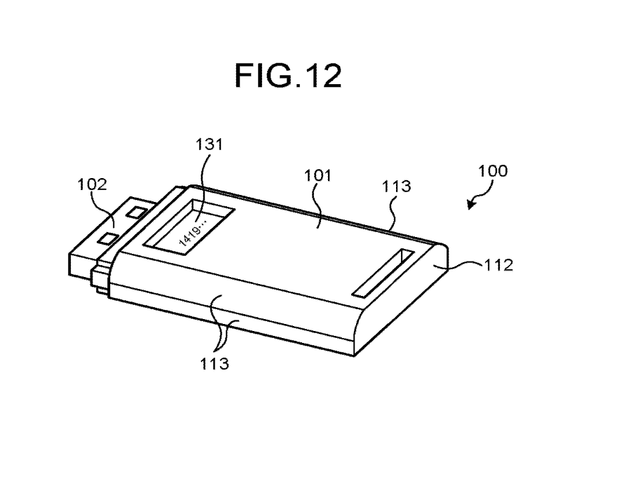

FIG. 12 is a schematic perspective diagram illustrating another example of the configuration of the USB memory according to the second embodiment. As illustrated in FIG. 12, a recess portion 131 may be formed on the main surface 111 of the USB memory 100, and the printing may be performed on the bottom of the recess portion 131 with the invisible ink. It is preferable that the recess portion 131 have such a size that the entire finger tip or the entire finger belly of the finger holding the case 101 cannot touch the bottom of the recess portion 131. The recess portion 131 is formed in this manner, so that it is possible to prevent the invisible ink printed on the bottom of the recess portion 131 from being peeled off. The recess portion 131 may be formed in the end surface 112 or the side surface 113 as well as in the main surface 111.

In the second embodiment, it is also possible to obtain the same effects as those of the first embodiment. In addition, the recess portion 131 is formed on the surface of the case 101 of the USB memory 100, and the printing is performed on the bottom of the recess portion 131 with the invisible ink. Accordingly, in comparison with the case where the printing is performed on the surface of the case 101, since the rate at which the finger of the user touches the invisible ink can be reduced, it is possible to obtain the effect of preventing the invisible ink from being peeled off.

### Third Embodiment

In the first and second embodiments, the cases where the traceability information is printed on the surface of the memory device with the invisible ink are illustrated. In a third embodiment, a memory device where traceability information is stored in a memory will be described.

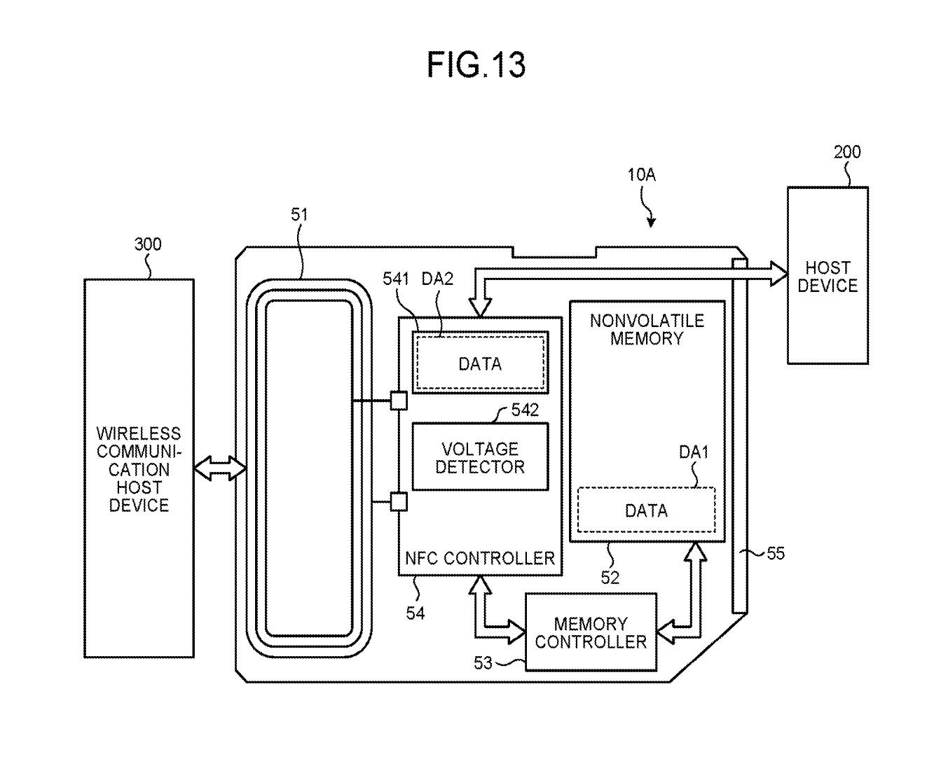

FIG. 13 is a schematic block diagram illustrating an example of a memory device 10A according to the third embodiment. The memory device 10A has a function of writing and reading data DA1 of a host device 200 by power supplied from the host device 200 electrically connected to the memory device and a function of communicating data DA2 by power generated (induced) by electromagnetic induction in a wireless antenna 51 without electrical connection to the wireless communication host device 300. Namely, for example, the memory device 10A performs communication in accordance with a short-range radio communication protocol (NFC: Near Field Communication) with a frequency of 13.56 MHz or the like to transmit/receive the data DA2 to/from the wireless communication host device 300. The memory device 10A is operable even though power is not supplied from the host device 200. In addition, in the figure, the host device 200 and the wireless communication host device 300 are illustrated as separate configuration, but the host device and the wireless communication host device may be in the same configuration.

The memory device 10A is configured to include a wireless antenna 51, a nonvolatile memory 52, a memory controller 53, an NFC controller 54, and a connection unit 55. In addition, the NFC controller 54 is configured to include a storage unit 541 and a voltage detector 542. Furthermore, the NFC controller 54 and the storage unit 541 may be configured so as to be separated from each other. In addition, the NFC controller 54 and the memory controller 53 may be implemented as one controller.

The wireless antenna 51 is set to a certain frequency or frequency band corresponding to the NFC. In addition, the wireless antenna 51 generates power by electromagnetic induction on the basis of a radio wave of the wireless communication host device 300. The wireless antenna 51 supplies the generated power to the NFC controller 54. The wireless antenna 51 receives data from the wireless communication host device 300 and outputs the data to the NFC controller 54. In addition, the wireless antenna 51 outputs data of the NFC controller 54 to the wireless communication host device 300. The wireless antenna 51 is, for example, a PCB (printed circuit board) pattern antenna.

The nonvolatile memory 52 is a storage medium capable of storing information in a nonvolatile manner. The nonvolatile memory 52 is configured to include, for example, a NAND type flash memory, a NOR type flash memory, an MRAM, a PRAM, an ReRAM, an FeRAM, or the like.

The memory controller 53 controls the nonvolatile memory 52. In a case where the memory controller 53 receives a write command and data DA1 from the host device 200, the memory controller writes the data DA1 in the nonvolatile memory 52. In a case where the memory controller 53 receives a read command, the memory controller reads the data DA1 from the nonvolatile memory 52. In a case where the memory controller 53 is supplied with power from the host device 200 and receives a write command and data DA1 through the wireless antenna 51 and the NFC controller 54, the memory controller may write the data DA1 in the nonvolatile memory 52. In addition, in a case where the memory controller 53 receives a read command, the memory controller may read the data DA1 from the nonvolatile memory 52 and output the data DA1 through the NFC controller 54 and the wireless antenna 51.

In addition, the memory controller 53 may control the storage unit 541. In a case where the memory controller 53 receives a write command, the memory controller 53 may write the data DA2 in the storage unit 541; and in a case where the memory controller 53 receives a read command, the memory controller 53 may read the data DA2 from the storage unit 541.

The nonvolatile memory 52 and the memory controller 53 operate with the power supplied from the host device 200.

The NFC controller 54 operates with the power generated in the wireless antenna 51 by electromagnetic induction on the basis of a radio wave of the wireless communication host device 300. In a case where the NFC controller 54 is in an operating period or receives a read command from the wireless communication host device 300 through the wireless antenna 51, the NFC controller reads the data DA2 from the storage unit 541 and outputs the data DA2 to the wireless communication host device 300 using the wireless antenna 51. In addition, in a case where the NFC controller 54 is in an operating period or receives a write command and data by using the wireless antenna 51, the NFC controller may be allowed to write the data DA2 in the storage unit 541.

The NFC controller 54 controls data reception and transmission with respect to the wireless communication host device 300 using the wireless antenna 51. More specifically, when the NFC controller 54 receives a signal having a certain frequency corresponding to the NFC through the wireless antenna 51, NFC communication can be performed.

In addition, in the period of writing on the nonvolatile memory 52, the NFC controller 54 outputs the write command and data DA1 received through the connection unit 55 from the host device 200 to the memory controller 53. In a case where the NFC controller 54 receives the write command and the data DA1 through the connection unit 55 from the host device 200, the NFC controller may output the write command and the data DA1 to the memory controller 53 to write the data DA1 in the storage unit 541.

In addition, in the period of reading from the nonvolatile memory 52, the NFC controller 54 outputs the data DA1 received from the memory controller 53 to the host device 200 through the connection unit 55.

The voltage detector 542 of the NFC controller 54 is electrically connected to the wireless antenna 51 to monitor a voltage supplied from the wireless antenna 51 to the NFC controller 54 and continue to issue a rest signal of NFC communication until the voltage reaches a certain voltage corresponding to the NFC. Therefore, it is possible to prevent abnormal startup or abnormal operation of NFC communication.

The NFC controller 54 may control the nonvolatile memory 52. In a case where the NFC controller 54 is supplied with power from the host device 200 and receives a write command and data DA1 from the host device 200, the NFC controller may write the data DA1 received from the host device 200 in the nonvolatile memory 52. In a case where NFC controller 54 is supplied with power from the host device 200 and receives a write command and data through the wireless antenna 51 and the NFC controller 54 in accordance with NFC, the NFC controller may write the data in the nonvolatile memory 52.

In a case where the NFC controller 54 is supplied with power from the host device 200 and receives a command of generating data DA2 from the host device 200, the NFC controller may read the data DA1 written in the nonvolatile memory 52 and may generate the data DA2 and write the data DA2 in the storage unit 541.

In a case where the NFC controller 54 is supplied with power from the host device 200 and receives a wireless output command, the NFC controller may read a portion of or all of the data DA1 written in the nonvolatile memory 52 and output the read data to the wireless communication host device 300 through the wireless antenna 51.

In a case where the NFC controller 54 receives command data and a write command by using the wireless antenna 51, the NFC controller may write the command data in the storage unit 541; and in a case where the NFC controller receives an execute command, the NFC controller may execute a process commanded by the command data written in the storage unit 541.

The storage unit 541 is configured to include, for example, an EEPROM (electrically erasable programmable read-only memory), a NAND type flash memory, or the like. The data DA2 are written in the storage unit 541 under the control of the NFC controller 54 or the memory controller 53. In addition, the retention of the data DA2 in the storage unit 541 may be temporary retention. The storage unit 541 is configured to include a user data region and an administration region. The user data region is a region where the user freely stores data. The administration region is a region which the user cannot access, and only an administrator having a special right can access the region. In the third embodiment, the traceability information of the memory device 10A is stored in the administration region. The traceability information is the same as that described in the first embodiment. In addition, access right information defining a right to the access to the traceability information may be stored in the administration region.

The NFC controller 54 and the storage unit 541 operate with the power induced in the wireless antenna 51 by the wireless communication host device 300. Therefore, it is preferable that the NFC controller 54 and the storage unit 541 can be driven with a lower power than the memory controller 53 and the nonvolatile memory 52. However, in a case where the memory device 10A is supplied with power from the host device 200, the NFC controller 54 and the storage unit 541 may operate by the power supplied from the host device 200.

The connection unit 55 is, for example, a standardized connection terminal and can be connected to the host device 200.

Note that, in the above example, the case where the traceability information is retained in the administration region of the storage unit 541 is described, the traceability information may be retained in the nonvolatile memory 52. In this case, when a read command for the traceability information is received from the wireless communication host device 300, the NFC controller 54 acquires the traceability information in the nonvolatile memory 52 through the memory controller 53 and returns the traceability information to the wireless communication host device 300. At this time, the read command is transferred from the NFC controller 54 to the memory controller 53, and the memory controller 53 reads the traceability information from the nonvolatile memory 52. The read traceability information is transmitted from the NFC controller 54 to the wireless communication host device 300 through the memory controller 53.

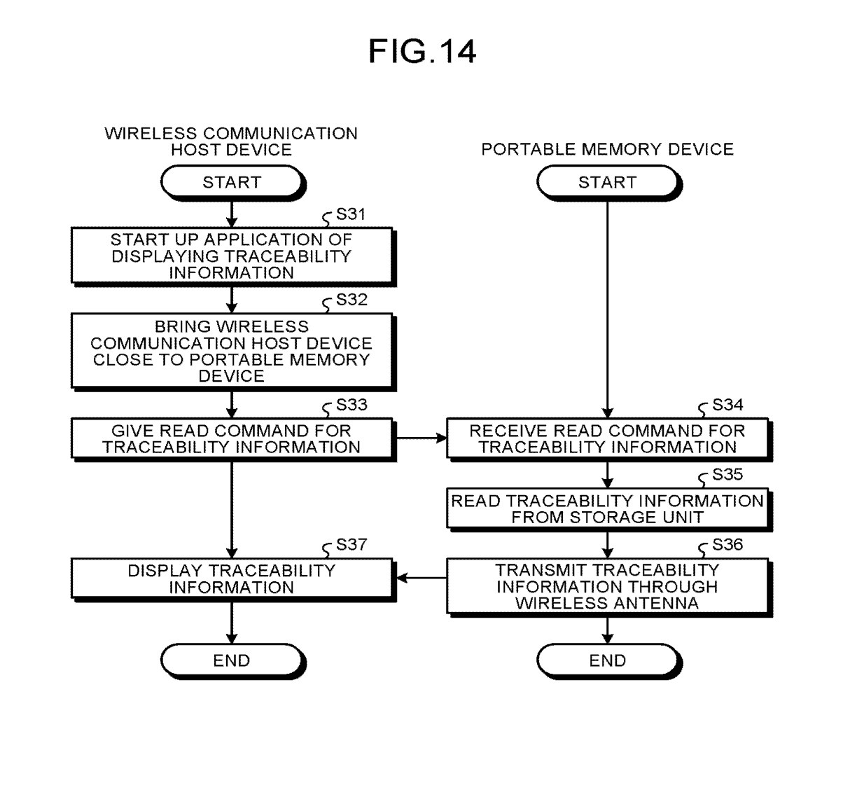

Next, a traceability information identifying method according to the third embodiment will be described. FIG. 14 is a flowchart illustrating an example of a procedure of the traceability information identifying method according to the third embodiment. In addition, it is assumed that an application (also referred to a program) of displaying the traceability information has been introduced in the wireless communication host device 300. For example, the application of displaying the traceability information is stored in a storage medium within a certain WEB server, and an administrator downloads (installs) the application to the wireless communication host device 300 via a network such as the Internet or a wireless LAN (a local area network), so that the administrator can start-up the application of displaying the traceability information from the wireless communication host device 300. In addition, in order that only the wireless communication host device 300 carried by the administrator can download the application of displaying the traceability information, access restriction may be imposed on the downloading of the application of displaying the traceability information by requiring a password or the like.

In addition, the above-described application is provided as a program. The program may be provided to be recorded as an installable format file or an executable format file in a computer-readable recording medium such as a CD-ROM, a flexible disk (FD), a CD-R, a DVD (a digital versatile disk), or a memory card.

The program is loaded in a RAM which is a memory in the wireless communication host device 300 and is executed by a CPU (a central processing unit) which is a control unit in the wireless communication host device 300, so that the application is executed.

The administrator starts up the application of displaying the traceability information 26 in the wireless communication host device 300 (step S31). Next, when the administrator brings the wireless communication host device 300 close to the memory device 10A (step S32), the application transmits a read command of reading the traceability information 26 from the storage unit 541 to the memory device 10A through the wireless antenna 51 (step S33). Alternatively, in step S32, the memory device 10A may be brought close to the wireless communication host device 300.

The wireless antenna 51 of the memory device 10A receives the read command from the wireless communication host device 300 (step S34), and the NFC controller 54 reads the traceability information 26 from the storage unit 541 (step S35) and transmits the traceability information to the wireless communication host device 300 through the wireless antenna 51 (step S36).

The application of the wireless communication host device 300 displays the traceability information 26 received from the memory device 10A on a display unit of the wireless communication host device 300 (step S37). The administrator can identify the traceability information 26 of the memory device 10A. In the manner described heretofore, the process ends.

In addition, for example, in the period of displaying the traceability information 26, the application of displaying the traceability information 26 may be a process of checking whether or not the administrator or the wireless communication host device 300 carried by the administrator has an access right and, after that, displaying the traceability information 26. The checking of whether or not to have the access right is determined by using access management information. As a method of determining whether or not to have the access right, for example, there is a method of displaying a screen prompting input of a password or the like in the display unit of the wireless communication host device 300 and checking whether the input password or the like agrees with the access management information.

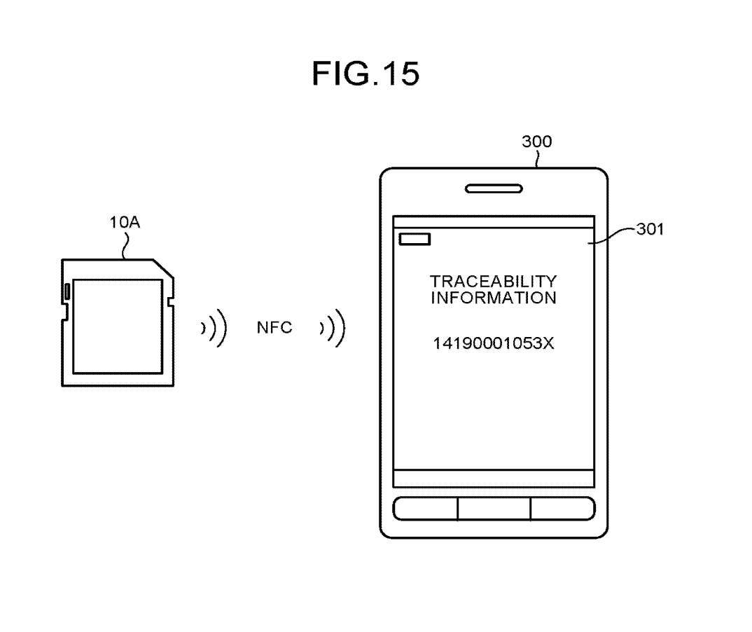

A specific example of the traceability information identifying process will be described. FIG. 15 is a schematic diagram illustrating a summary of the traceability information identifying method according to the third embodiment. When the wireless communication host device 300, which is a smartphone, is held over the memory device 10A, the traceability information 26 stored in the memory device 10A is transmitted to the wireless communication host device 300. The wireless communication host device 300 displays the traceability information 26 on the display unit 301. The administrator can perform history investigation for the memory device 10A based on the displayed traceability information 26.

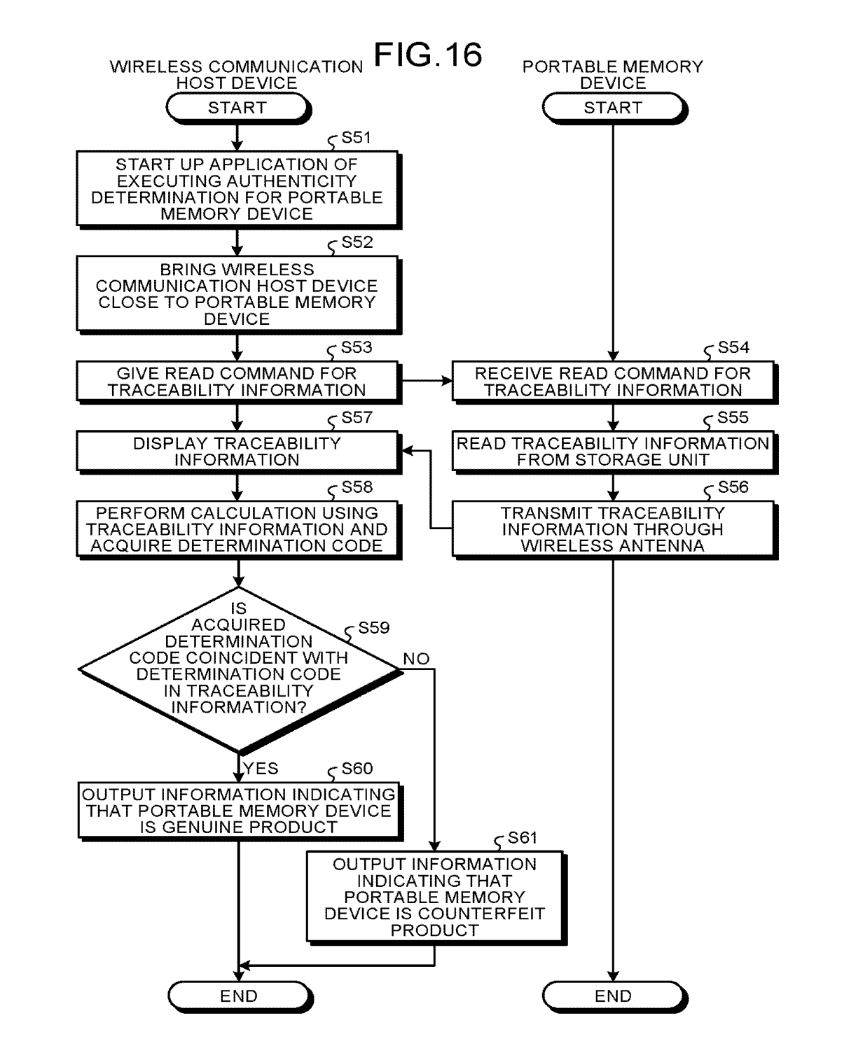

In addition, the application of the wireless communication host device 300 may perform authenticity determination using the traceability information 26 acquired from the memory device 10A. FIG. 16 is a flowchart illustrating an example of a procedure of the authenticity determination using the traceability information according to the third embodiment. In addition, it is assumed that an application of executing the authenticity determination for the memory device 10A using the traceability information 26 has been introduced in the wireless communication host device 300.

The administrator starts up the application of executing the authenticity determination for the memory device 10A in the wireless communication host device 300 (step S51). Next, when the administrator brings the wireless communication host device 300 close to the memory device 10A (step S52), the application transmits a read command of reading the traceability information 26 from the storage unit 541 to the memory device 10A through the wireless antenna 51 (step S53). Note that, in step S52, the memory device 10A may be brought close to the wireless communication host device 300.

The wireless antenna 51 of the memory device 10A receives the read command from the wireless communication host device 300 (step S54), and the NFC controller 54 reads the traceability information 26 from the storage unit 541 (step S55) and transmits the traceability information to the wireless communication host device 300 through the wireless antenna 51 (step S56).

The application of the wireless communication host device 300 displays the received traceability information 26 on the display unit of the wireless communication host device 300 (step S57). In addition, the application performs calculation using the traceability information 26 to acquire the determination code (step S58). The calculation process using the traceability information 26 and the determination code acquisition process are the same as those of the first embodiment, and thus, the description thereof will not be repeated.

Next, the application determines whether or not the acquired determination code is coincident with the determination code in the traceability information 26 (step S59). In a case where both are coincident (in a case of Yes in step S59), the application outputs information indicating that the memory device 10A as a determination object is a genuine product (step S60), and the process ends. On the other hand, in a case where both are not coincident (in a case of No in step S59), the application outputs information indicating that the memory device 10A as a determination object is a counterfeit product (step S61), and the process ends. In the manner described heretofore, the administrator can perform the authenticity determination for the memory device 10A on the basis of the traceability information 26.

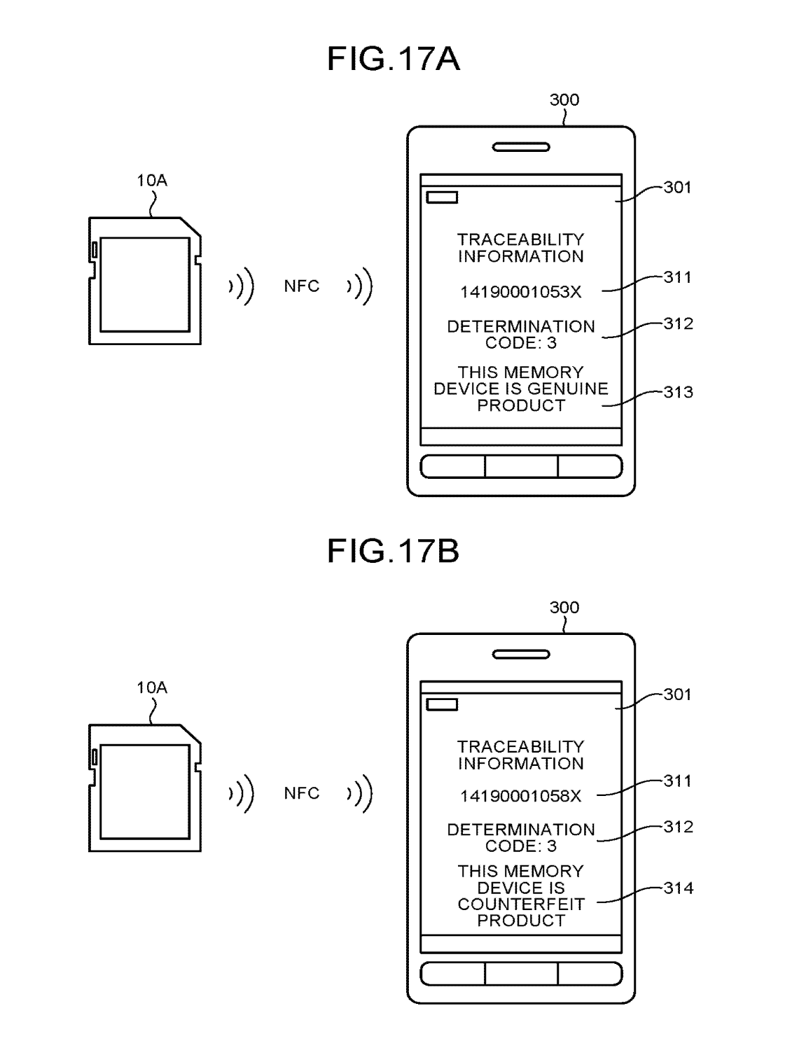

A specific example of the authenticity determination process for the memory device 10A will be described. FIG. 17A and FIG. 17B are schematic diagram illustrating a summary of an authenticity determination method for the memory device 10A according to the third embodiment. If the memory device 10A is held over the wireless communication host device 300 which is a smartphone, the traceability information stored in the memory device 10A is transmitted to the wireless communication host device 300. The wireless communication host device 300 displays traceability information 311 on the display unit 301. In addition, a calculation process is performed using the traceability information, and a determination code 312 is acquired, and the determination code 312 is also displayed on the display unit 301. Next, in a case where the determination code 312 is coincident with the determination code in the traceability information 311, information 313 indicating that the product is a genuine product is displayed on the display unit 301 as illustrated in FIG. 17A. Alternatively, in a case where the determination code 312 is not coincident with the determination code in the traceability information 311, information 314 indicating that the product is a counterfeit product is displayed on the display unit 301 as illustrated in FIG. 17B.

In the above description, the memory card is exemplified. However, the same process may be executed by a USB memory if the wireless antenna 51 and the NFC controller 54 are installed in the USB memory.

In the third embodiment, the traceability information is retained in the storage unit 541 of the memory device 10A which can perform wireless communication in accordance with the NFC. As a result, it is possible to obtain an effect in that, if the memory device 10A and the wireless communication host device 300 are located within a certain distance or less, the traceability information can be displayed in the wireless communication host device 300, so that the administrator can identify the traceability information.

In addition, the determination code described in the first embodiment is allowed to be included in the traceability information. Therefore, it is possible to obtain an effect in that the authenticity determination for the memory device 10A can be performed in the application of the wireless communication host device 300 using the traceability information.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A nonvolatile semiconductor memory device comprising:
a case;
a memory in the case; and
a controller in the case, the controller controlling the memory, wherein
first information including a determination code is printed on a surface of the case with invisible ink, and
second information related to the nonvolatile semiconductor memory device is printed with visible ink which is visually recognizable in a visible light range.

2. The nonvolatile semiconductor memory device according to claim 1, wherein the first information is information including traceability information of the nonvolatile semiconductor memory device, the traceability information including the determination code.

3. The nonvolatile semiconductor memory device according to claim 1, wherein the first information is printed to be superimposed on the second information.

4. The nonvolatile semiconductor memory device according to claim 1, wherein the first information further includes at least one of a manufacturer's name, a country-of-origin indication, and a model number of the nonvolatile semiconductor memory device.

5. The nonvolatile semiconductor memory device according to claim 1, wherein the invisible ink is ultraviolet irradiation type fluorescence ink or infrared irradiation type fluorescence ink.

6. The nonvolatile semiconductor memory device according to claim 1, wherein
the traceability information includes a year of manufacture, a week number, a lot number, and a controller code indicating a type of the controller of the nonvolatile semiconductor memory device,
the second information includes the traceability information, and
the determination code is obtained by performing certain calculation with digit of an operand number and corresponding digit of an operating number, obtaining a total sum of calculation results, and defining the last one digit of the total sum as the determination code; the operand number is obtained by excluding the controller code from the traceability information; and the operating number is obtained by repetitively arranging the week number to have the same number of digits as that of the operand number.

7. The nonvolatile semiconductor memory device according to claim 6, wherein the certain calculation is defined for every year of manufacture.

8. The nonvolatile semiconductor memory device according to claim 1, wherein the nonvolatile semiconductor memory device is any one of an SD card, a miniSD card, and a microSD card.

9. The nonvolatile semiconductor memory device according to claim 1, wherein the case encloses a board on which the memory and the controller are mounted, the board including a connector having a terminal for data communication with an external device.

10. The nonvolatile semiconductor memory device according to claim 9, wherein the first information is printed in any one of end portions of main surfaces of the case close to the connector, an end surface opposite to the connector of the case, and end portions of side surfaces close to the end surface; the main surfaces being parallel to a board plane of the case; and the side surfaces connecting the end portions of a pair of the main surfaces.

11. The nonvolatile semiconductor memory device according to claim 9, wherein
the case has a recess portion, and
the first information is printed in the recess portion.

12. A memory device comprising:
a connector which is capable of electrically connecting to a first host device;
a first memory configured to operate with electric power which is supplied from the first host device via the connector;
a first controller configured to operate with electric power which is supplied from the first host device via the connector, and control the first memory;
a wireless antenna configured to produce electric power based on a radio wave from a second host device;
a second memory configured to be capable of operating with the produced electric power; and
a second controller configured to be capable of operating with the produced electric power, perform communication with the second host device via the wireless antenna complying with a near field communication standard and control the second memory,
wherein the second memory stores traceability information of the memory device, and
the second controller reads the traceability information from the second memory and sends the traceability information to the second host device by using the wireless antenna in response to a read command for the traceability information from the second host device.

13. The memory device according to claim 12, wherein the traceability information includes a determination code, and the determination code is obtained from the traceability information of the memory device by certain calculation.

14. The memory device according to claim 13, wherein
the traceability information includes a year of manufacture, a week number, a lot number, and a controller code indicating a type of a controller of the memory device, the controller being at least one of the first controller and the second controller, and
the determination code is obtained by performing certain calculation with digit of an operand number and corresponding digit of an operating number, obtaining a total sum of calculation results, and defining the last one digit of the total sum as the determination code; the operand number is obtained by excluding the controller code from the traceability information; and the operating number is obtained by repetitively arranging the week number to have the same number of digits as that of the operand number.

15. The memory device according to claim 14, wherein the certain calculation is defined for every year of manufacture.

16. The memory device according to claim 12, wherein the case is any one of an SD card, a miniSD card, and a microSD card.

17. A storage medium storing a control program loaded on a host device, the host device being capable of communicating with a memory device based on a near field communication standard, the memory device including a wireless antenna, a nonvolatile semiconductor memory, and a controller, wherein the control program causes the host device to execute:
generating a command for reading traceability information from the memory device as a command which complies with the near field communication standard;
transmitting the command to the memory device;
receiving the traceability information from the memory device; and
displaying the received traceability information on a display unit,
wherein the wireless antenna is configured to comply with the near field communication standard,
the nonvolatile semiconductor memory is configured to be capable of operating with the produced electric power, and
the controller is configured to be capable of operating with the produced electric power, perform communication with the host device via the wireless antenna complying with the near field communication standard and control the nonvolatile semiconductor memory.

18. The storage medium according to claim 17, wherein the control program further causes the host device to execute:
executing certain calculation using the traceability information;
determining whether a result of the calculation is coincident with a determination code in the traceability information; and
outputting information indicating that the memory device is a counterfeit product in a case where the result of the calculation is not coincident with the determination code in the traceability information.

19. The storage medium according to claim 18, wherein the control program further causes the host device to execute outputting information indicating that the memory device is a genuine product in a case where the result of the calculation is coincident with the determination code in the traceability information.

20. The storage medium according to claim 18, wherein
the traceability information includes a year of manufacture, a week number, a lot number, and a controller code indicating a type of the controller of the nonvolatile semiconductor memory, and
in the execution of the certain calculation, the certain calculation is performed with digit of an operand number and corresponding digit of an operating number, a total sum of calculation results is obtained, the last one digit of the total sum is defined as the result of the calculation; the operand number is obtained by excluding the controller code from the traceability information; and the operating number is obtained by repetitively arranging the week number to have the same number of digits as that of the operand number.
